(19) United States
(12) Patent Application Publication
(10) Pub. No.: US 2025/0039307 A1
(43) Pub. Date: Jan. 30, 2025

(54) PRINTED IMAGE INSPECTION SYSTEM

(71) Applicant: CANON KABUSHIKI KAISHA, Tokyo (JP)

(72) Inventor: KATSUYUKI MURAKAMI, Chiba (JP)

(21) Appl. No.: 18/784,020

(22) Filed: Jul. 25, 2024

(30) Foreign Application Priority Data
Jul. 25, 2023 (JP) 2023-120518

(51) Int. Cl. H04N 1/00

(52) U.S. Cl. CPC H04N 1/00015; H04N 1/00334; H04N 2201/3216

(57) ABSTRACT

A testing apparatus configured to connect to an image forming apparatus includes a controller having one or more processors which executes instructions stored in one or more memories, the controller being configured to extract a character string from a designated area on a scanned image acquired by scanning a printed product with an image printed thereon based on a job, acquire information about the job, and perform testing on the printed product based on the acquired information about the job by comparing the character string extracted by an extraction unit with a correct value referred to from reference data.

### BACKGROUND

### Field of the Disclosure

The present disclosure relates to an inspection apparatus and an inspection system.

### Description of the Related Art

While printed products have been inspected manually, a recent apparatus that performs inspection automatically as post-processing of a printing machine is used. The inspection apparatus first registers correct image data. Next, an image forming apparatus prints input image data on a sheet, and an image reading apparatus in the inspection apparatus reads the data printed on the sheet. By comparing the image data read by the image reading apparatus with the correct image data registered first using an inspection personal computer (inspection PC) capable of performing processing in real time, defective images in the printed products are detected. Testing for detecting defective images in the printed products will be referred to as printed image testing.

Further, not only the printed image testing but also testing of a variable area such as a character string or a barcode in variable printing is also performed. Examples include data readability testing for checking whether a character string or a barcode is readable and data verification testing for verifying the result of reading a character string or a barcode against a correct character string referred to in variable data. The data readability testing and the data verification testing will be referred to as data testing.

Japanese Patent Application Laid-Open No. 2007-233820 discusses a technique in which data from a database is substituted into a variable area where printing content can be changed and the data extracted from the variable area in a scanned image is compared with the database.

### SUMMARY

According to an aspect of the present disclosure, a testing apparatus configured to connect to an image forming apparatus includes a controller having one or more processors which executes instructions stored in one or more memories, the controller being configured to extract a character string from a designated area on a scanned image acquired by scanning a printed product with an image printed thereon based on a job, acquire information about the job, and perform testing on the printed product based on the acquired information about the job by comparing the character string extracted by an extraction unit with a correct value referred to from reference data.

Further characteristics of the present disclosure will become apparent from the following description of exemplary embodiments with reference to the attached drawings.

### BRIEF DESCRIPTION OF THE DRAWINGS

FIG. 1 is a diagram illustrating an example of the overall configuration of an inspection system according to one or more aspects of the present disclosure.

FIG. 2 is a diagram illustrating the internal configuration of an image forming apparatus 100 according to one or more aspects of the present disclosure.

FIG. 3 is a sequence diagram illustrating a process of registering correct images and testing settings according to one or more aspects of the present disclosure.

FIG. 4 is a sequence diagram illustrating an inspection process according to one or more aspects of the present disclosure.

FIG. 5 is a flowchart illustrating a process of extracting correct images and variable data that correspond to print pages according to one or more aspects of the present disclosure.

FIG. 6 illustrates an example of a user interface (UI) screen related to print settings for the correct image registration according to one or more aspects of the present disclosure.

FIG. 7 illustrates an example of a UI screen for inputting testing settings according to one or more aspects of the present disclosure.

FIG. 8 illustrates an example of a UI screen related to print settings in testing according to one or more aspects of the present disclosure.

FIGS. 9A to 9D illustrate an example of the configuration of variable data according to one or more aspects of the present disclosure.

FIG. 10 illustrates an example of a testing data structure in testing settings according to one or more aspects of the present disclosure t.

FIG. 11 is a sequence diagram illustrating a process of registering correct images and testing settings according to one or more aspects of the present disclosure.

FIG. 12 is a sequence diagram illustrating an inspection process according to one or more aspects of the present disclosure.

FIG. 13 illustrates an example of a UI screen related to print settings in testing according to one or more aspects of the present disclosure.

### DESCRIPTION OF THE EMBODIMENTS

Various exemplary embodiments of the present disclosure will be described with reference to the drawings. Components according to the exemplary embodiments are merely examples and not intended to limit the scope of the disclosure.

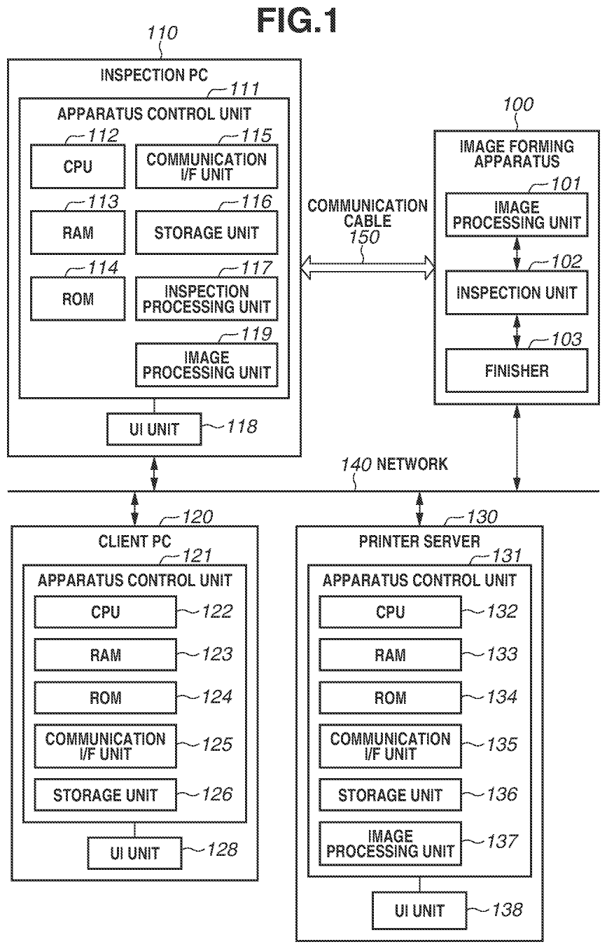

A first exemplary embodiment will be described. FIG. 1 is a diagram illustrating the entire configuration of a system including an inspection apparatus (testing apparatus) according to the present exemplary embodiment of the present disclosure. The system includes an image forming apparatus 100, an inspection personal computer (inspection PC) 110, a client personal computer (client PC) 120, a printer server 130, a network 140, and a communication cable 150. According to the present exemplary embodiment, the term “inspection apparatus” is a collective term for the inspection PC 110, the combination of the inspection PC 110 and an inspection unit 102, or the combination of the image forming apparatus 100 and the inspection PC 110.

The image forming apparatus 100 outputs prints based on various types of input data, such as document data transmitted from the client PC 120 or the printer server 130. Further, the image forming apparatus 100 includes an image processing unit 101, the inspection unit 102, and a finisher 103, and the image processing unit 101, the inspection unit 102, and the finisher 103 are connected to each other via a communication cable that is an internal bus.

The image processing unit 101 performs image processing according to print settings based on various types of input data and outputs a printed product generated by printing an image having undergone the image processing on a recording sheet.

The inspection unit 102 receives the printed product output from the image processing unit 101 and acquires a read image (scanned image) by scanning and reading the printed product. The read image acquired herein is image data for testing to determine whether there is a defective image on the inspection PC 110. The term “defective image” herein refers to something that lowers the quality of the printed product. Examples include circular defective images (spots) caused by color materials put on unintended portions in printing, color dropout caused by an insufficient amount of a color material put on the intended portion, and line-shaped defective images (streaks).

Then, the acquired image data is transferred to the inspection PC 110 described below via the communication cable 150, and testing is performed on the inspection PC 110 to determine whether the printed product includes a defective image. Then, the inspection unit 102 acquires the testing result from the inspection PC 110.

The finisher 103 receives output sheets tested by the inspection unit 102 and changes the sheet discharge destination based on the testing result of the inspection PC 110 and/or performs post-processing (such as bookbinding) as appropriate.

The image forming apparatus 100 is connected to the inspection PC 110, the client PC 120, and the printer server 130 via the network 140. The image forming apparatus 100 is further connected to the inspection PC 110 via the communication cable 150 and communicates image data in inspection and inspection results with the inspection PC 110. While the inspection PC 110 performs inspection according to the present exemplary embodiment, the present exemplary embodiment is not a limitation, and other configurations, such as an inline inspection device that performs image forming, inspection, post-processing, and sheet discharge seamlessly, can be also used. A detailed configuration of the image forming apparatus 100 according to the present exemplary embodiment will be described below.

The inspection PC 110 is a PC for inspecting images read from printed products using the inspection unit 102 and includes an apparatus control unit 111 and a user interface 118 (hereinafter, referred to as “UI unit”). Further, the apparatus control unit 111 includes a controller board, and a central processing unit (CPU) 112, a random access memory (RAM) 113, a read-only memory (ROM) 114, a communication interface (communication I/F) unit 115, a storage unit 116, an inspection processing unit 117, and an image processing unit 119 are mounted on the apparatus control unit 111. According to the present exemplary embodiment, the modules communicate with each other via an internal system bus (not illustrated).

The CPU 112 reads a main program from the storage unit 116 based on an initial program in the storage unit 116 and stores the read main program in the RAM 113. The RAM 113 is used for storing programs and as a main memory for work. The ROM 114 is used to temporarily store data generated during processes of programs. The communication I/F unit 115 is used in communicating via the network 140 or the communication cable 150. The storage unit 116 is used to store data, such as programs, and large data, such as image data. The inspection processing unit 117 calculates the difference value between a correct image stored as a correct image in the RAM 113 and a testing target scanned image to perform testing to determine whether image data acquired by the inspection unit 102 includes a defective image, such as contamination or color dropout. Next, the inspection processing unit 117 performs testing by comparing, for each pixel, each calculated difference value with a testing threshold (contrast, size) of each testing item. Then, the testing results, such as information indicating whether the printed product includes a defective image and defective image position information in displaying detected defective image types (spot, streak) on the UI unit 118, are stored in the RAM 113. Then, the testing results are transmitted to the inspection unit 102 via the communication cable 150.

The image processing unit 119 performs image processing to convert the image data into an optimal resolution for testing.

The UI unit 118 is composed of, for example, a keyboard, a mouse, a display, and other input/output devices, and various setting values or designated values can be input via the UI unit 118.

The client PC 120 is a PC that is connected to the inspection PC 110 and the printer server 130 and receives user operations. The client PC 120 includes an apparatus control unit 121 and a UI unit 128. Further, the apparatus control unit 121 includes a controller board, and a CPU 122, a RAM 123, a ROM 124, a communication I/F unit 125, and a storage unit 126 are mounted on the apparatus control unit 121. The roles of the components in the client PC 120 are similar to those of their corresponding components in the inspection PC 110, respectively, so that redundant descriptions thereof are omitted. The printer server 130 is a server configured to perform a raster image processing (RIP) process for printing document data or text data. Further, the printer server 130 controls printing by an image forming apparatus 110 and manages print jobs. The printer server 130 includes an apparatus control unit 131 and a UI unit 138. Further, the apparatus control unit 131 includes a controller board, and a CPU 132, a RAM 133, a ROM 134, a communication I/F unit 135, a storage unit 136, and an image processing unit 137 are mounted on the apparatus control unit 131.

Except for the image processing unit 137, the roles of the components in the printer server 130 are similar to those of their corresponding components in the client PC 120, respectively, so that redundant descriptions thereof are omitted.

The image processing unit 137 performs a RIP process for printing document data or text data transmitted from the client PC 120 based on the print settings and converts the data into bitmapped image data. Specifically, the RIP process for printing is a process of generating images without decreasing a resolution of 600 dpi.

The overall system configuration including the inspection apparatus according to an exemplary embodiment of the present disclosure has been described above.

The image forming apparatus 100, the inspection PC 110, the client PC 120, and the printer server 130 can communicate with each other via the network 140. Further, the present exemplary embodiment is not a limitation, and any other form can be used, such as a form in which each apparatus connects to another apparatus via a network.

### [Diagram Illustrating Configuration of Image Forming Apparatus]

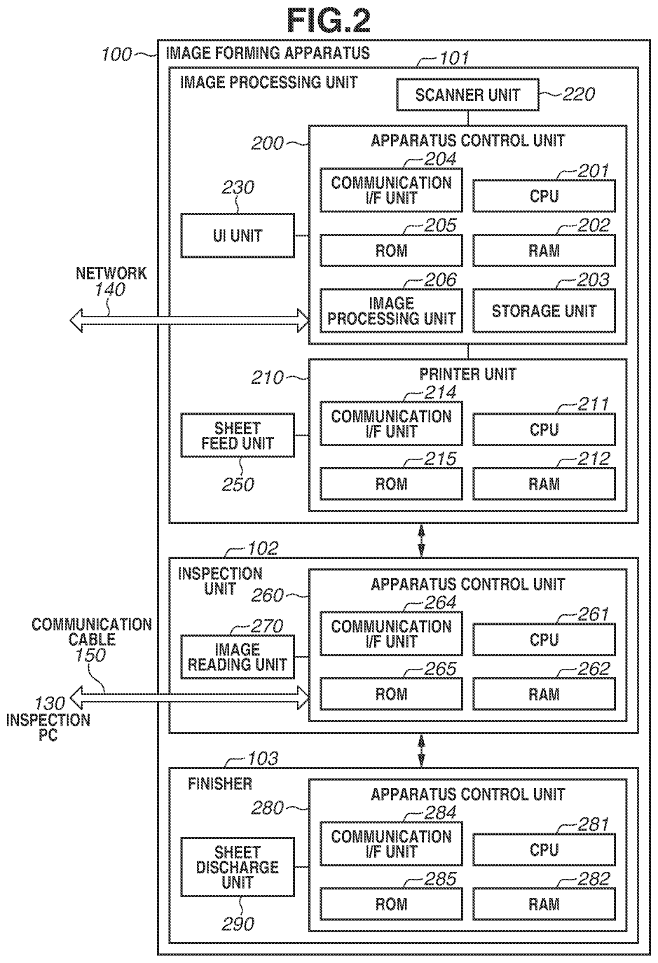

FIG. 2 is a diagram illustrating an internal configuration of the image forming apparatus 100 according to the present exemplary embodiment.

The image forming apparatus 100 includes the image processing unit 101, the inspection unit 102, and the finisher 103.

Further, the image processing unit 101 includes an apparatus control unit 200, a printer unit 210, a scanner unit 220, a UI unit 230, and a sheet feed unit 250.

The apparatus control unit 200 receives images and documents from the network 140 and converts the received images and documents into print data. Further, a CPU 201, a RAM 202, a storage unit 203, a communication I/F unit 204, a ROM 205, and an image processing unit 206 are mounted on the apparatus control unit 200. The roles of the foregoing components are similar to those of their corresponding components in the printer server 130, respectively, so that redundant descriptions thereof are omitted.

The image processing unit 206 acquires page description language (PDL) data stored in the RAM 202 and performs image processing to convert the PDL data into print data. The image processing of conversion into print data involves, for example, performing a RIP process on PDL data to convert the PDL data into multi-valued bitmap data and performing pseudo-halftoning processing, such as screen processing, to convert the multi-valued bitmap data into binary bitmap data. The binary bitmap data obtained by the image processing unit 206 is transmitted to the printer unit 210 via the communication I/F unit 204.

The printer unit 210 conveys a sheet (recording sheet, recording medium) from the sheet feed unit 250, receives binary bitmap data generated by the apparatus control unit 200, and performs printing on the sheet using color materials. At this time, instructions are issued to the printer unit 210 based on the print settings designated by the user. For example, with the print settings to use coated paper, a CPU 211 issues instructions to print using a sheet cassette (not illustrated) storing coated paper in the sheet feed unit 250. The various processes from the receiving of PDL data to the printing of the PDL data on a sheet are controlled by the apparatus control unit 200 and the printer unit 210, forming a full-color toner image on the sheet. Further, the CPU 211, a RAM 212, a communication I/F unit 214, and a ROM 215 are mounted on the printer unit 210. The roles of the foregoing components are similar to those of their corresponding components in the apparatus control unit 200, respectively, so that redundant descriptions thereof are omitted.

The scanner unit 220 is a device that uses a light source (not illustrated) to irradiate a document image, passes the reflected document image through a lens to, for example, a charge-coupled device (CCD) sensor, and acquires signals of the document reflection image read from the CCD sensor as red, green, and blue multi-valued image data.

The UI unit 230 is composed of, for example, a keyboard, a mouse, a display, and other input/output devices, and various setting values or designated values can be input via the UI unit 230.

The sheet feed unit 250 is a device including one or more cassettes in which sheets for printing are set, and a sheet is fed from a cassette corresponding to a sheet size specified in the print settings and conveyed to the printer unit 210.

The inspection unit 102 includes an apparatus control unit 260 and an image reading unit 270.

The image reading unit 270 is an image reading unit that reads printed products conveyed from the image processing unit 101. The image reading unit 270 is a device that uses a light source (not illustrated) irradiates a document to be printed, passes the document reflection image through a unity magnification conjugate lens system to a contact image sensor (CIS), and acquires information from the CIS as red, green, and blue multi-valued image data. The image reading unit 270 according to the present exemplary embodiment is not limited to CIS sensors, and a CCD sensor can be used to acquire image data.

The apparatus control unit 260 performs control to transfer the image data acquired by the image reading unit 270 to the inspection PC 110 described below via the communication cable 150. Then, the transferred image data is used on the inspection PC 110 to determine whether the printed product includes a defective image, and the testing results are acquired from the inspection PC 110 and transmitted to the finisher 103. A CPU 261, a RAM 262, a communication I/F unit 264, and a ROM 265 are mounted on the apparatus control unit 260. The roles of the foregoing components are similar to those of their corresponding components in the apparatus control unit 200, respectively, so that redundant descriptions thereof are omitted.

The finisher 103 includes an apparatus control unit 280 and a sheet discharge unit 290.

The apparatus control unit 280 determines the sheet discharge control to be performed by the sheet discharge unit 290 taking into account the print settings and the inspection results. A CPU 281, a RAM 282, a communication I/F unit 284, and a ROM 285 are mounted on the apparatus control unit 280. The roles of the foregoing components are similar to those of their corresponding components in the apparatus control unit 200, respectively, so that redundant descriptions thereof are omitted.

The sheet discharge unit 290 is a device that switches sheet discharge destinations of printed products conveyed from the inspection unit 102 based on the print settings, post-processing (e.g., bookbinding), or inspection results. For example, in switching the sheet discharge destination of a printed product depending on the presence or absence of a defective image, the finisher 103 discharges printed products without a defective image to a normal sheet discharge tray or discharges printed products with a defective image to another tray different from the normal sheet discharge tray using the testing results received from the inspection unit 102.

The image forming apparatus 100 according to the present exemplary embodiment of the present disclosure has been described above. The configuration according to the present exemplary embodiment is not a limitation, and any other form can be used that can print document data and read an image for testing to determine whether the printed product includes a defective image.

### [Correct Image Processing Procedure of Inspection System]

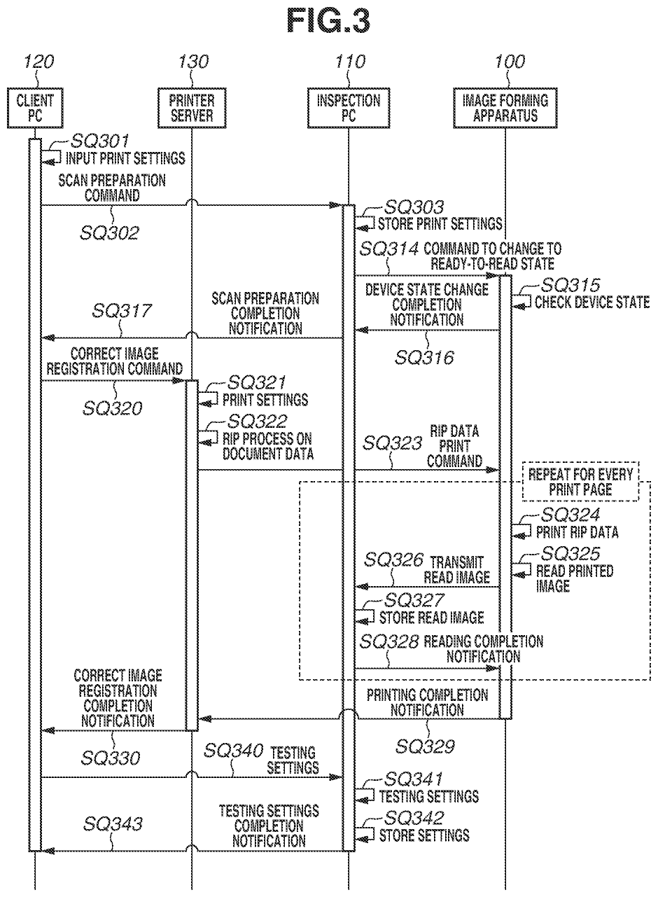

FIG. 3 is a diagram illustrating a process procedure for registering correct images and testing settings in the inspection system by the user before testing. In this procedure, a printed product generated by printing document data is scanned by the image reading unit 270 to acquire a read image, and the read image is registered as correct image data. By executing the procedure, the registration of correct images and testing settings prior to the printed product testing is completed.

For the processes in FIG. 3, the client PC 120, the printer server 130, the inspection PC 110, and the image forming apparatus 100 receive commands from the user and perform the processing described below.

Further, the client PC 120 executes the process in response to an instruction to start the correct image registration received from the user.

At this time, the process of the inspection PC 110 is executed by program codes stored in the storage unit 116 being loaded into the RAM 113 and the apparatus control unit 111 being controlled by the CPU 112. Further, the process of the client PC 120 is executed by program codes stored in the storage unit 126 being loaded into the RAM 123 and the apparatus control unit 121 being controlled by the CPU 122. Further, the process of the printer server 130 is executed by program codes stored in the storage unit 136 being loaded into the RAM 133 and the apparatus control unit 131 being controlled by the CPU 132. Further, the process of the image forming apparatus 100 is executed by program codes stored in the storage unit 203 being loaded into the RAM 202 and the apparatus control unit 200 being controlled by the CPU 201.

First, in step SQ301, the client PC 120 receives, from the user, a print setting instruction for generating a correct image for use in testing.

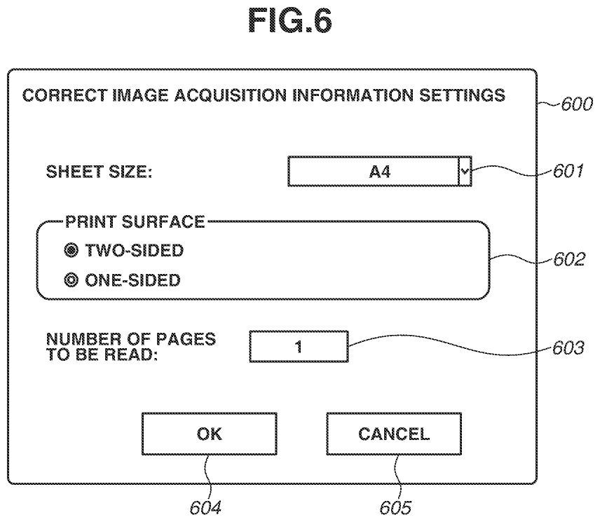

FIG. 6 is a diagram illustrating an example of UIs for configuring information related to the print settings for correct images.

A UI 600 in FIG. 6 is a UI screen for inputting print settings related to an inspection process and is displayed on the UI unit 128 of the client PC 120.

First, a list box 601 is a list box in which the user selects to set a sheet size for use in printing and inspection. According to the present exemplary embodiment, standard-sized sheets within a sheet size range printable by the image forming apparatus 100 and non-standard-sized sheets that can be designated by the user are selectable. If a non-standard-sized sheet is selected, sizes in height and width directions are input separately.

Next, a radio button 602 is a radio button that the user presses to select between two-sided surfaces and one-sided surface as a print surface.

Next, a textbox 603 is a textbox for user input to set the total number of pages of document data. The process from step SQ324 to step SQ328 described below is repeated for the number of print pages set in the textbox 603.

A button 604 is a button that the user presses to store the setting values set by the user after all the print settings related to the correct image registration are completed. A button 605 is a button that the user presses to cancel the settings related to the correct image registration.

When the button 605 is pressed by the user, information being configured is discarded, and the correct image registration procedure ends.

The UIs for configuring the print settings related to the correct image registration according to the present exemplary embodiment have been described above.

Next, in step SQ302, the client PC 120 issues, to the inspection PC 110, a command of scan preparation performed by the image reading unit 270 to generate scanned images to be registered as correct images based on the print settings configured in step SQ301.

Next, in step SQ303, the inspection PC 110 stores the print settings for the correct images that are notified in step SQ302.

Next, in step SQ314, the inspection PC 110 issues, to the image forming apparatus 100, a command of scan preparation performed by the image reading unit 270.

Next, in step SQ315, the image forming apparatus 100 checks the device state of the image reading unit 270 and changes to a scan standby state.

Next, in step SQ316, the image forming apparatus 100 notifies the inspection PC 110 that the image reading unit 270 is in the scan standby state.

Next, in step SQ317, the inspection PC 110 notifies the client PC 120 that the image reading unit 270 is in the scan standby state and the correct image generation preparation is complete.

Next, in step SQ320, the notification received in step SQ317 triggers the client PC 120 to issue, to the printer server 130, a command to execute the process for the correct image registration. According to the present exemplary embodiment, document data is transmitted together with the correct image registration command from the client PC 120 to the printer server 130, making the document data received by the printer server 130 source data for the RIP process described below.

Next, in step SQ321, the printer server 130 stores settings for performing the RIP process based on the print settings configured in step SQ301.

Next, in step SQ322, the printer server 130 performs the RIP process on each page of the document data one by one based on the print settings stored in step SQ321 and generates RIP data.

Next, in step SQ323, the printer server 130 issues, to the image forming apparatus 100, a command to print the RIP data subjected to the RIP process in step SQ322. At this time, the print settings are transmitted from the printer server 130 to the image forming apparatus 100.

Next, in step SQ324, the printer unit 210 in the image forming apparatus 100 prints each page one by one based on the RIP data received in step SQ323 and the print settings designated by the user and received in step SQ323.

Next, in step SQ325, the apparatus control unit 260 in the image forming apparatus 100 acquires scanned image data generated by reading the printed product printed in step SQ324 using the image reading unit 270.

Next, in step SQ326, the image forming apparatus 100 transmits the scanned image data read in step SQ325 to the inspection PC 110 via the communication cable 150.

Next, in step SQ327, the inspection PC 110 stores the scanned image data transmitted in step SQ326.

Next, in step SQ328, the inspection PC 110 notifies the image forming apparatus 100, via the communication cable 150, that the storing of the scanned image data read in step SQ325 is complete. The process from step SQ324 to step SQ328 is repeated for each print page of the document data.

Next, in step SQ329, the image forming apparatus 100 notifies the printer server 130 that the process of printing the document data and storing the scanned correct image data up to step SQ328 is complete.

Next, in step SQ330, the printer server 130 notifies the client PC 120 that the process of printing the document data and storing the scanned correct image data up to step SQ328 is complete.

Next, in step SQ340, the client PC 120 issues, to the inspection PC 110, an instruction to configure testing settings for performing an inspection.

Next, in step SQ341, the inspection PC 110 sets various testing parameters, such as a testing area and a testing level, based on the testing settings configured by the user. Details of UIs for configuring the testing settings in step SQ341 according to the present exemplary embodiment will be described below.

Next, in step SQ342, the inspection PC 110 ends the testing settings configured in step SQ341, stores the various testing parameters, such as the testing area and the testing level, and changes to a state of being ready for testing.

Next, in step SQ343, the inspection PC 110 notifies the client PC 120 that the testing settings are complete, allowing notification to the user of the completion of the series of operations of registering correct images and testing settings.

A process procedure for registering correct images and testing settings before testing according to the present exemplary embodiment has been described above.

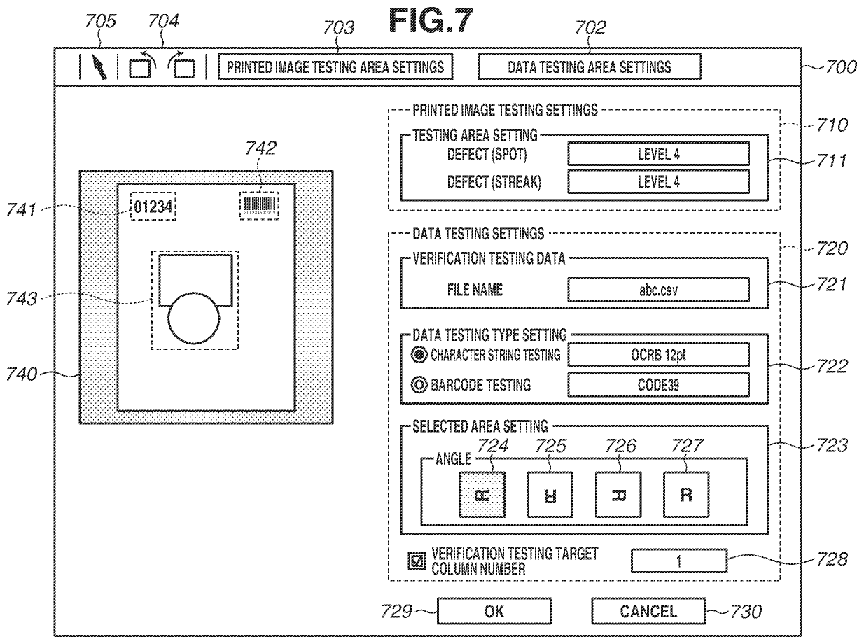

An example of UIs for the testing settings will now be described with reference to FIG. 7.

A UI screen 700 in FIG. 7 is a UI screen that is displayed on the UI unit 118 of the inspection PC 110 at the timing of configuring testing settings for testing in step SQ340.

A page preview 740 is a display screen where a scanned image read in step SQ325 is displayed as a correct image.

A button 702 is a button that the user presses to set data testing areas. A method for setting data testing areas according to the present exemplary embodiment will be described according to the following procedure. First, the button 702 for data testing area settings is pressed by a user operation. Then, data testing target areas are designated in the page preview 740 by a user operation, so that the inspection PC 110 sets the corresponding designated ranges on the scanned image as data testing areas 741 and 742. The data testing areas are testing areas as designated areas for reading a set data type (character string or barcode) and determining whether it is correct or incorrect.

A button 703 is a button that the user presses to set printed image testing areas. A method for setting printed image testing areas according to the present exemplary embodiment will be described according to the following procedure.

First, the button 703 for printed image testing area settings is pressed by a user operation. Then, a printed image testing target area is designated in the page preview 740 by a user operation, so that the inspection PC 110 sets the corresponding designated range as a printed image testing area 743. The printed image testing area is a testing area for detecting defective images in picture portions of the printed product.

A button 704 is a button for rotating an image displayed in the page preview 740.

A button 705 is a testing area selection button that the user presses to change previously-set area setting information.

A UI 710 is a UI group for setting levels for defective images to be detected in the printed image testing.

A UI 711 is a UI for setting detection items in the defective image detection in the printed image testing and detection levels of the detection items. The detection items in the printed image testing refer to items related to characteristics of defective images to be detected in the printed product testing, and examples include round-shaped defective images (spots) and line-shaped defective images (streaks). Detection levels refer to parameters set for each characteristic of detected defective images to indicate size levels at which defective images begin to be detected. For example, there are five levels from level 1 to level 5, and thinner and smaller defective images are detected at level 5 than at level 1. Further, a level can be set for each testing item, e.g., testing level 5 for spots and testing level 4 for streaks. The UI 711 indicates that testing level 4 is selected for defective images (spots) and for defective images (streaks) by the user.

A UI 720 is a UI group for setting a data file, a data testing type, and detailed information about the data testing type to be referred to in verifying detected data in the data testing. The data testing areas are testing areas for reading the set data type (character string or barcode) and determining whether it is correct or incorrect.

A UI 721 is a UI for setting a variable data file for use as correct text information in determining whether it is correct or incorrect in the data testing using a file selection method.

Variable data (reference data) according to the present exemplary embodiment refers to a reference comma-separated values (reference CSV) file for data testing that is used to verify as correct in the data testing. The reference CSV file is a file listing comma-separated correct character strings for character string testing and barcode testing. Further, the reference CSV file is used as data that is input to variable areas in generating document data for variable printing. Since the document data is generated by referring to the reference CSV file, the data orders match. This makes it possible to verify character string testing areas and barcode reading results against the correct character strings listed in the reference CSV file in the data testing. If the print order of the document data is changed, the data order of the referenced CSV file no longer matches, so that it is no longer possible to verify against the correct character strings listed in the reference CSV file. Further, the UI 721 in FIG. 7 indicates that data with the file name abc.csv is selected as verification testing data. The CSV file is stored in advance in the storage unit 116.

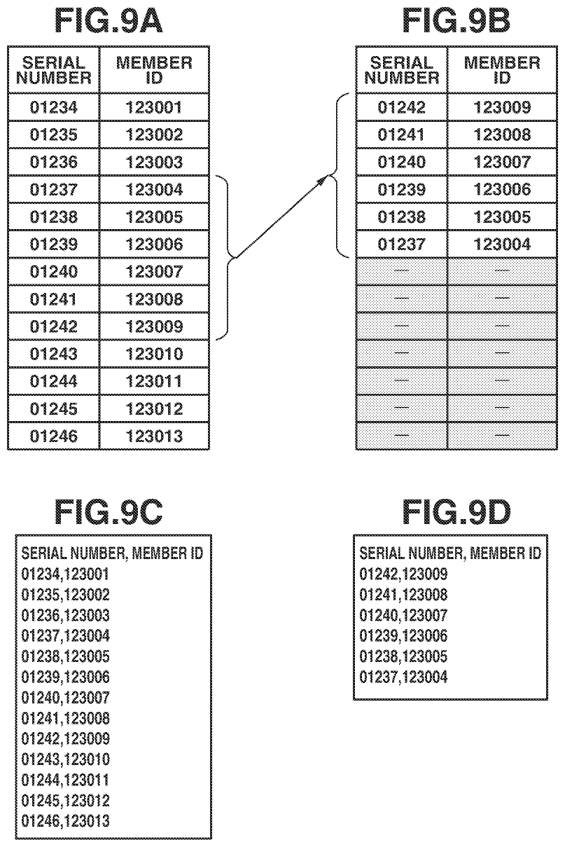

An example of a CSV file will be described with reference to FIGS. 9A to 9D. Variable printing using variable data is, for example, a method of changing an address and name by client and printing the changed address and name in sending direct mail. Further, variable data refers to variable data for changing the address and name by client. Specifically, an area where the address and name are printed is a variable area (variable area), and the variable area is an area where printing content changes by page of a printed product. In FIG. 9A, each row indicates data for each client, and serial numbers and member identifiers (member IDs) are recorded in different columns. Specifically, a character string described on the first page is described in the first row of the data, and a character string described on the second page is described in the second row of the data. Further, a label can be described in the first row to improve the readability for the user using the CSV file, and if the label is described, the row is skipped. According to the present exemplary embodiment, the client data is printed on one sheet at a time, and each time one sheet is printed, the client data in the next row in the CSV file is read. Further, while a CSV file needs to be prepared for each piece of print data, there is a case where only an image portion to be a template is changed and printing is performed. In this case, the same CSV file can be used.

While the CSV files separate the data with commas, an existing spreadsheet application displays the data in a framework like a table. If a CSV file is checked using not a spreadsheet application but a text editor, the data separated with commas is displayed in a data format as illustrated in FIG. 9C. Further, while a serial number and a correct value are specified in one row according to the present exemplary embodiment, a serial number can be displayed in combination with a page number and/or an area number. Further, if one page includes a plurality of variable areas, a plurality of correct values can be described in one row. For example, if there are correct values for the data testing areas 741 and 742 in FIG. 7, one column can be added to the right in FIG. 9A to describe the correct values in it.

Next, a UI 722 is a UI for setting a type of character string testing or barcode testing selected by the user using a radio button method and a pull-down method.

The character string type according to the present exemplary embodiment refers to a font data set associating character shape images with character codes for character recognition (optical character recognition (OCR)). To store the font data set in advance, the user can print a character shape image and perform a registration process of associating the character shape image with a character code, or the corresponding font data set can be set in advance in the shipped state. The UI 722 in FIG. 7 indicates that the selected shape font of the character string testing is OCRB 12 pt. The settings for the character string testing are configured for the data testing area 741, and OCRB 12 pt specified via the UI 722 is selected.

Further, the barcode type according to the present exemplary embodiment refers to a barcode standard for the data testing. For example, a one-dimensional barcode, such as CODE39 or Japanese article number (JAN) barcode, or a two-dimensional code, such as a quick response code (QR code®) or a DataMatrix code, is selectable via the UI 722 if the code is a standard for the data testing. According to the present exemplary embodiment, barcodes and QR codes are collectively referred to as code images. The UI 722 in FIG. 7 indicates that the selected barcode testing is CODE39. The settings for the barcode testing are configured for the data testing area 742, and CODE39 is selected.

A UI 723 is a UI for setting a direction of reading a character string or a barcode in the data testing based on the testing settings set by the user and is composed of direction setting buttons 724 to 727.

The direction setting buttons 724 to 727 correspond to 0°, 90°, 180°, and 270°, respectively, which are 90-degree increments clockwise from a sheet conveyance direction. In the sheet conveyance direction according to the present exemplary embodiment, sheets are conveyed from right to left in the page preview 740 in FIG. 7. Thus, the angle setting for the direction setting button 724 with the character oriented in the sheet conveyance direction is 0°. Further, since the rotation is in 90-degree increments clockwise from the conveyance direction, the angle settings for the direction setting buttons 725, 726, and 727 are 90°, 180°, and 270°, respectively. The direction setting buttons 724 to 727 are set to correspond to a display angle of the character string or the barcode displayed in the page preview 740. While the direction setting buttons 724 to 727 are used to set the direction of reading a character string or a barcode according to the present exemplary embodiment, the present exemplary embodiment is not a limitation, and a UI (e.g., radio button) via which the direction can be set can be used.

A UI 728 is a UI for setting whether the verification testing is to be executed on the read character string against the correct character string in the CSV file set via the UI 721 in the data testing based on the testing settings set by the user using a checkbox method and a textbox. Whether the verification testing is to be executed is selected by setting a check button. Then, if the checkbox is checked, a column in the CSV file to be referred to as a correct character string is determined based on an input value in the textbox. The input value to receive via the textbox is an integer of 1 or greater, and if a CSV file is read in advance, the maximum number of columns in the CSV file can be determined to be an upper limit value. While the column number to be referred to is designated via the textbox according to the present exemplary embodiment, the first row of the variable data can be read, and a UI using a pull-down method with the first row being a label value can be used. The present exemplary embodiment is not a limitation, and any other method for designating a column number to be referred to in the CSV file can be used.

Further, if the checkbox is not checked, the verification testing is not executed. In this case, the textbox to be referred to as a correct character string can be grayed out so that no input can be entered into the textbox.

A button 729 is a button for executing testing after all the testing settings are completed. A button 730 is a button for cancelling the testing settings, and if the button 730 is pressed by the user, information being configured is discarded, and the testing settings end.

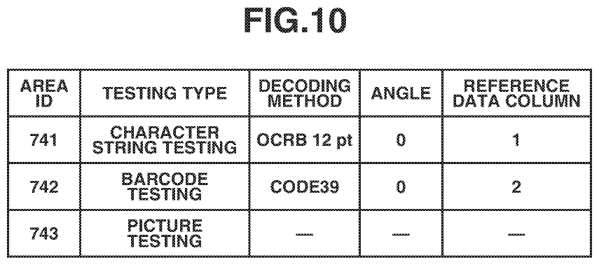

FIG. 10 illustrates an example of setting values stored as testing settings after the testing settings are complete based on user operations.

For each set testing area, an area identifier (area ID), a testing type, a decoding method, an angle, and a verification testing reference column are stored.

The area ID is a unique identifier (ID) assigned for each testing area of the data testing or the printed image testing set via the button 702 or 703.

The testing type is used for setting a supported testing type, such as printed image testing, character string testing, or barcode testing.

The decoding method is used for setting a type of decoding for converting the read image into a character string in the data testing (character string testing, barcode testing) and stores the setting value of the UI 722. For the printed image testing according to the present exemplary embodiment, no settings are necessary, so that “-” is input.

The angle is used for setting the direction of reading the character string or the barcode in the data testing (character string testing, barcode testing) and stores the setting value of the button selected in the UI 723. For the printed image testing according to the present exemplary embodiment, no settings are necessary, so that “-” is input.

The verification testing reference column is used for setting a column number in the CSV file to be referred to in the verification testing in the data testing (character string testing, barcode testing) and stores the value input to the UI 728. For the printed image testing and the data testing without the verification testing according to the present exemplary embodiment, no settings are necessary, so that “-” is input.

UIs for configuring the testing settings for the inspection process according to the present exemplary embodiment have been described above. Even after the testing settings in FIG. 7 are completed, the testing settings can be retrieved by the user and adjusted again.

[Testing Execution Procedure of Inspection System]

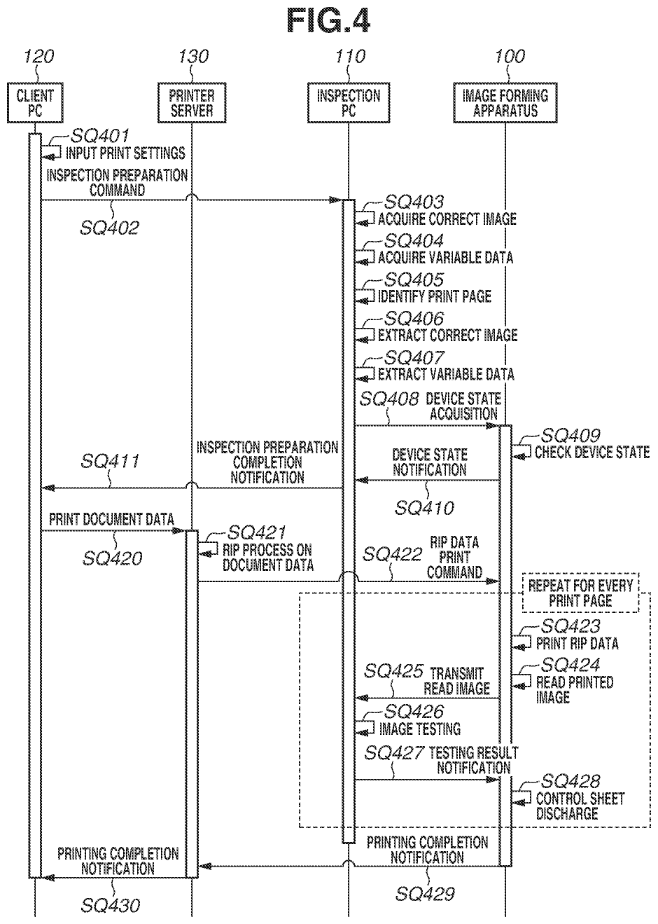

FIG. 4 is a diagram illustrating a process procedure in which the user performs printing using the image forming apparatus 100 via the printer server 130 and the inspection PC 110 performs testing to determine whether the printed product includes a defective image based on the testing settings configured in FIG. 3.

For the processes in FIG. 4, the client PC 120, the printer server 130, the inspection PC 110, and the image forming apparatus 100 receive commands from the user and perform processing described below.

Then, if an instruction of a printing and inspection execution button from the user is received, the client PC 120 executes the process.

At this time, the process of the inspection PC 110 is executed by program codes stored in the storage unit 116 being loaded into the RAM 113 and the control of the CPU 112 of the apparatus control unit 111. Further, the process of the client PC 120 is executed by program codes stored in the storage unit 126 being loaded into the RAM 123 and the apparatus control unit 121 being controlled by the CPU 122. Further, the process of the printer server 130 is executed by program codes stored in the storage unit 136 being loaded into the RAM 133 and the apparatus control unit 131 being controlled by the CPU 132. Further, the process of the image forming apparatus 100 is executed by program codes stored in the storage unit 203 being loaded into the RAM 202 and the apparatus control unit 200 being controlled by the CPU 201.

First, in step SQ401, the client PC 120 configures, based on a user instruction, the print settings that are to be commanded to the image forming apparatus 100 in performing printing and testing.

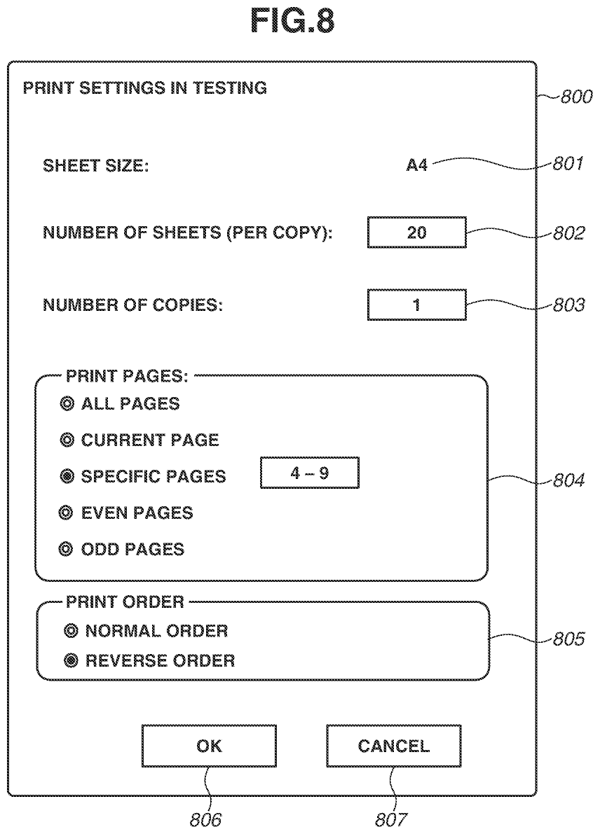

FIG. 8 is a diagram illustrating an example of UIs for configuring information related to the print settings in testing.

A UI 800 in FIG. 8 is a UI screen for inputting the print settings related to the inspection process and is displayed on the UI unit 128 of the client PC 120.

First, a label 801 is a label for displaying a sheet size configured in the testing settings. According to the present exemplary embodiment, since the sheet size configured in the testing settings is not changeable, not a list box but the label is displayed so that the sheet size cannot be selected or changed.

Next, a textbox 802 is a textbox for displaying the number of sheets per copy that is configured in the testing settings. According to the present exemplary embodiment, the number of sheets per copy that is configured in the testing settings is a value input to the textbox 603 and is not changeable. Thus, the textbox operation is disabled so that the textbox 802 cannot be selected or changed.

Next, a textbox 803 is a textbox for inputting the number of copies of the testing target printed product.

Next, a UI 804 is a UI group for setting printing target pages selected by the user using a radio button method and a textbox method. Patterns of printing target pages that can be selected using the radio buttons are “all pages”, “current page”, “specific pages”, “even pages”, and “odd pages”.

The radio button “all pages” is a radio button that is selected to print all the pages of the document data.

The radio button “current page” is a radio button that is selected to print only a displayed page of the document data displayed on an application.

The radio button “specific pages” is a radio button that is selected to set document pages to be printed by the user. If the “specific pages” is set, the range of print pages that are intended to be set is input to the textbox. At this time, separators can be used as a method for setting specific pages. For example, according to the present exemplary embodiment, commas “,” are used to separate pages, and hyphens “-” are used to designate a range of pages. If “4-9” is described in the textbox in the UI 804, pages 4 to 9 are set as pages to be printed.

The radio button “even pages” is a radio button that is selected to print even pages of the document data.

The radio button “odd pages” is a radio button that is selected to print odd pages of the document data.

The present exemplary embodiment is not a limitation, and any other method for designating pages to be printed can be used.

Next, a radio button 805 is a radio button for setting a print order in printing the document data. If “normal order” is selected, the document data is printed in ascending order from the first page, whereas if “reverse order” is selected, the document data is printed in descending order from the last page.

A button 806 is a button for executing printing and testing after all the print settings are completed. A button 807 is a button for cancelling the print settings, and if the button 807 is pressed by the user, information being configured is discarded, and the printing and testing end.

The UIs for configuring information related to the print settings in testing according to the present exemplary embodiment have been described above.

If “specific pages” in the UI 804 is selected, the setting value of “specific pages” can be input automatically. For example, there is a job of resuming an interrupted printing/testing job due to a malfunction in the image forming apparatus 100. The total number of printed sheets that is calculated by multiplying the set number of sheets per copy by the set number of copies is compared with the number of tested sheets, and if the number of tested sheets is less than the total number of printed sheets, the printing/testing job may have been interrupted. In this case, the testing job may have been resumed, so that the page range from the interrupted page to the last page can be input in advance. Furthermore, if there is no change in the numerical value input automatically, a pop-up (not illustrated) can be displayed to notify the user.

Next, in step SQ402, the client PC 120 issues an inspection preparation command to the inspection PC 110. The testing settings for use in the inspection configured in step SQ341 and the print settings configured in step SQ401 are used.

Next, in step SQ403, the inspection PC 110 acquires the correct images acquired in step SQ327.

Next, in step SQ404, if the data testing involving the verification testing is set with the testing settings configured in step SQ341, the inspection PC 110 acquires the set variable data.

Next, in step SQ405, the inspection PC 110 identifies the specific printing target pages and the print order using the settings related to the printing target pages and configured in step SQ401. For example, if “all pages” and “reverse order” are set, the pages are set in descending order from the last page, whereas if “specific pages”, “1-10”, and “normal order” are set, pages 1 to 10 are set in ascending order.

Next, in step SQ406, the inspection PC 110 extracts the correct images corresponding to the printing target pages identified in step SQ405 and rearranges the correct images in the print order.

Next, in step SQ407, the inspection PC 110 extracts the variable data corresponding to the print pages identified in step SQ405 and rearranges the extracted variable data in the print order. For example, if there is variable data corresponding to 13 pages as illustrated in FIG. 9A and “specific pages”, “4-9”, and “reverse order” are set, 6 pages of data starting with the data in the ninth row, which is the data for page 9, are extracted. Consequently, the data rearranged and re-edited as illustrated in FIG. 9B is complete. Then, the re-edited data is changed to a data format as illustrated in FIG. 9D. While the extracted variable data is temporarily stored in the storage unit 116 and the process is performed without storing the extracted variable data in a file according to the present exemplary embodiment, the extracted variable data can be stored in a file to keep a record of the testing.

While rearranged data is described as being present as a separate file that has been actually re-edited according to the present exemplary embodiment, correct values can be referred to from the variable data in the order of the set specific pages.

Next, in step SQ408, the inspection PC 110 issues, to the image forming apparatus 100, a command to notify whether the device is in a printable and inspectable state.

Next, in step SQ409, the image forming apparatus 100 acquires states indicating whether the image processing unit 101, the inspection unit 102, and the finisher 103 are in a usable state, and determines whether the image forming apparatus 100 is in a printable and inspectable state.

Next, in step SQ410, the image forming apparatus 100 notifies the inspection PC 110 whether the image forming apparatus 100 is in a printable and inspectable state based on the determination in step SQ409.

Next, in step SQ411, the inspection PC 110 notifies the client PC 120 that the preparation for executing the inspection is complete based on the printable and inspectable state notification in step SQ409.

Next, in step SQ420, the client PC 120 issues, to the printer server 130, a command to print using the document data and the print settings designated by the user.

Next, in step SQ421, the printer server 130 performs the RIP process using the document data transmitted in step SQ420 and the print settings designated by the user and transmitted in step SQ420. According to the present exemplary embodiment, the RIP process on the document data is performed prior to the process from step SQ422. The document data according to the present exemplary embodiment refers to document data that supports variable printing. Furthermore, the document data refers to print data composed of a variable area where a character string, a barcode, or an image is changed based on data referred to in the reference CSV file and a fixed area where a template image or drawing data is used.

Next, in step SQ422, the printer server 130 issues, to the image forming apparatus 100, a command to print using the RIP data generated in step SQ421 and the print settings designated by the user.

Next, in step SQ423, the printer unit 210 in the image forming apparatus 100 prints one page at a time based on the RIP data received in step SQ422 and the print settings designated by the user and received in step SQ422.

Next, in step SQ424, the apparatus control unit 260 in the image forming apparatus 100 acquires scanned image data generated by reading the printed product printed in step SQ423 using the image reading unit 270.

Next, in step SQ425, the image forming apparatus 100 transmits the scanned image data read in step SQ424 to the inspection PC 110 via the communication cable 150.

Next, in step SQ426, the inspection PC 110 performs image testing using the scanned image data received in step SQ425, the correct images extracted in step SQ406, and the variable data extracted in step SQ407. Not only the image testing but also the testing to determine whether the scanned image data includes a defective image and the verification testing by extracting a data testing area from the scanned image data, decoding the data testing area into a character string based on the testing settings, and verifying the read character string against reference data are performed. At this time, not only information indicating whether the printed product includes a defective image but also the type (spot, streak) of a detected defective image and a scanned image of a nearby area detected as a defect or the entire page are stored. Further, the verification results of the read character string in the area having undergone the data testing against the reference data are also stored.

Next, in step SQ427, the inspection PC 110 notifies the testing results of step SQ426 to the image forming apparatus 100 via the communication cable 150.

Next, in step SQ428, the image forming apparatus 100 switches the sheet discharge destination of the finisher 103 based on the testing results received in step SQ427. For example, printed products without a detected defective image are discharged to a finisher tray designated by the user, whereas printed products with a detected defective image are discharged to a tray for defective images. Further, the present exemplary embodiment is not a limitation, and if a defective image is detected, reprinting can be performed automatically by the number of sheets corresponding to the number of sheets that have the defective image. By performing reprinting each time a defective image is detected, a set of printed products without a defective image is complete on the finisher tray.

Then, if the printing of all the pages of the document data is not completed, the printing and the inspection from step SQ423 to step SQ428 are repeated until all the pages are printed.

Next, in step SQ429, the image forming apparatus 100 notifies the printer server 130 that the printing and the inspection of all the pages of the document data are complete.

Next, in step SQ430, the printer server 130 notifies the client PC 120 that the printing and the inspection of all the pages of the document data are complete, allowing the user to be notified that the printing and the inspection are complete.

The process procedure in which printing is performed using the image forming apparatus 100 via the printer server 130 and the inspection PC 110 performs testing to determine whether the printed product includes a defective image based on the testing settings configured in FIG. 3 has been described above.

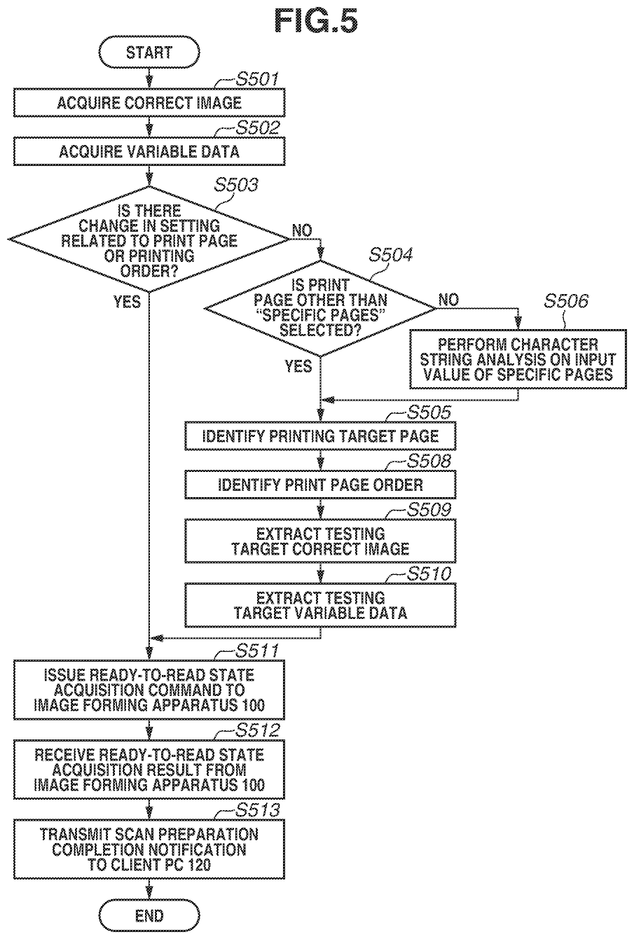

A detailed procedure of the process of extracting correct images and variable data that correspond to the print page order determined from the print settings in the process from step SQ403 to step SQ410 according to the present exemplary embodiment will now be described with reference to FIG. 5. By executing the process, printing target pages and the order of the printing target pages are determined from the specific print pages and the print order setting of the print settings, and correct images and variable data that correspond to the determined printing target pages and the determined order are extracted, making it possible to perform testing in which the print pages and the variable data match. The process of the inspection PC 110 is executed by program codes stored in the storage unit 116 being loaded into the RAM 113 and the apparatus control unit 111 being controlled by the CPU 112.

First, in step S501, the inspection PC 110 acquires the correct images stored in step SQ327. The process of step S501 is similar to the process of step SQ403.

Next, in step S502, if the data testing involving the verification testing is set in the testing settings configured in step SQ341, the inspection PC 110 acquires the set variable data. The process of step S502 is similar to the process of step SQ404.

Next, in step S503, the inspection PC 110 determines whether there is a change from the initial values of the setting values of the print pages and the print order in the testing settings acquired in step S502. If there is no change from the initial value settings (YES in step S503), no correct image extraction and variable data extraction are necessary, so that in step S511, the inspection PC 110 issues a command to notify whether the device is in a printable and inspectable state. The process of step S511 is similar to the process of step SQ409. Further, according to the present exemplary embodiment, the initial value of the print pages is “all pages”, and the initial value of the print order is “normal order”.

In step S503, if there is a change from the initial value settings (NO in step S503), a correct image extraction and a variable data extraction are necessary, so that it is determined whether the setting of the printing target pages is based on a predefined rule. For example, if the setting is based on a rule, such as even pages, printing target pages can be identified, whereas if the setting is “specific pages”, which allows the user to set printing target pages freely and is not based on a rule, it is necessary to identify printing target pages. Thus, in step S504, the inspection PC 110 determines whether the setting value of the print pages is a setting value other than “specific pages”.

If the setting value of the print pages is a setting value other than “specific pages” (YES in step S504), in step S505, the inspection PC 110 identifies printing target pages based on the setting value of the print pages input to the UI 804. For example, if the setting is “current page”, only the page corresponding to the displayed page number is extracted, whereas if the setting is “even pages”, only the even pages are extracted. Similarly, if the setting is “odd pages”, only the odd pages are extracted.

In step S504, if the setting value of the print pages is “specific pages” (NO in step S504), in step S506, the inspection PC 110 performs a character string analysis on the setting value input to the textbox for the specific pages and identifies printing target pages. In the character string analysis according to the present exemplary embodiment, if “1-10” is input, in order to understand that the input indicates a range from the first to tenth pages, lexical analysis is first performed to break the character string into categories, such as numbers or symbols. Next, if the symbol “-” is included, which is a symbol that indicates a printing range, the character string is composed of a starting page, the symbol, and an ending page. Then, the range of pages is identified from the numbers before and after the symbol “-”, and the range is interpreted as the first to tenth pages.

Further, if the symbol “,” is included, which is a separator between pages, even with numbers input before and after the symbol, the numbers are not applied as a page range. For example, if “3, 6” is input, that is interpreted as indicating to print pages 3 and 6.

The present exemplary embodiment is not a limitation, and any commonly-used method can be used for identifying print pages from an input value of specific pages.

Next, in step S505, the inspection PC 110 identifies printing target pages based on the analysis results of step S506.

Next, in step S508, the inspection PC 110 identifies the order of the printing target pages based on the setting value of the print order. For example, if the setting value of the print pages is “specific pages” and “1-6” and the setting value of the print order is “reverse order”, the order of the printing target pages is 6, 5, 4, 3, 2, 1.

By performing the process from step S504 to step S508, the process of step SQ405 for identifying the print pages and the order of the print pages is executed.

Next, in step S509, the inspection PC 110 extracts correct images corresponding to the print pages identified in step S505 or S507 and rearranges the extracted correct images in the print order. The process of step S509 is similar to the process of step SQ406.

Next, in step S510, the inspection PC 110 extracts variable data corresponding to the print pages identified in step S505 or S507 and rearranges the extracted variable data in the print order. The process of step S510 is similar to the process of step SQ407, so that detailed descriptions thereof are omitted.

Next, in step S511, the inspection PC 110 issues, to the image forming apparatus 100, a command to notify whether the device is in a printable and inspectable state. The process of step S511 is similar to the process of step SQ408.

Next, in step S512, the inspection PC 110 receives, from the image forming apparatus 100, the printable and inspectable state determined based on the command in step S511. The process of step S512 is similar to the process of step SQ410.

Next, in step S513, the inspection PC 110 notifies the client PC 120 that the preparation for executing the inspection is complete based on the printable and inspectable state notified in step S512. The process of step S513 is similar to the process of step SQ411.

While in the present exemplary embodiment, printing target pages are identified based on the print page setting in testing and variable data and correct image data are extracted, only variable data can be extracted. An example is a case where only pages of one user are printed instead of registering all printing target pages as correct images. In this case, the pages of one user are printed as one copy in registering correct images, whereas the pages of all users are printed in printing and testing. At this time, in the printed image testing, there are not correct images for all the pages, the printed image testing is performed repeatedly for the number of copies corresponding to the value of users without correct images being replaced. Then, in the data testing, the row to be referred to in the CSV file needs to be changed for each user, the data testing is performed to extract variable data based on the input print page setting. Thus, only one copy of correct images is to be printed in performing testing, making it possible to reduce unnecessary waste paper even if variable printing is a testing target.

Further, while printing target pages are identified based on the print page setting in testing and variable data is extracted, the printing can be interrupted if a character string read in data testing does not match the corresponding correct character string in verification. For example, if a page setting on an application via which the print settings are set and a print page setting input to the UI 800 differ from each other, the printing is interrupted to check the result, making it possible to reduce unwanted printing.

As described above, printing target pages are identified based on the print page setting in testing, and correct images and correct character strings of variable data are changed simultaneously, making it possible to perform printed image testing and data inspection in which the correct images and the correct character strings match.

A second exemplary embodiment will be described. In the above-described method according to the first exemplary embodiment, with image data read by the image reading unit 270 of the image forming apparatus 100 determined to be correct images, printing target pages are identified based on the print page setting in testing, and the correct images and correct character strings of reference data are changed. In this case, the print settings are configured using UIs without notification of job setting information between the inspection PC 110 and the printer server 130. According to the present exemplary embodiment, the inspection PC 110 and the printer server 130 communicate notifications of job setting information with each other, and RIP images are used as correct images. Printing target pages are identified based on the print page setting in testing. A method of performing printed image testing and data inspection in which correct images and correct character strings of reference data match will be described. RIP images refer to images generated by converting document data or text data into bitmapped image data.

Differences of the present exemplary embodiment from the first exemplary embodiment will be described.

### [Correct Image Processing Procedure of Inspection System]

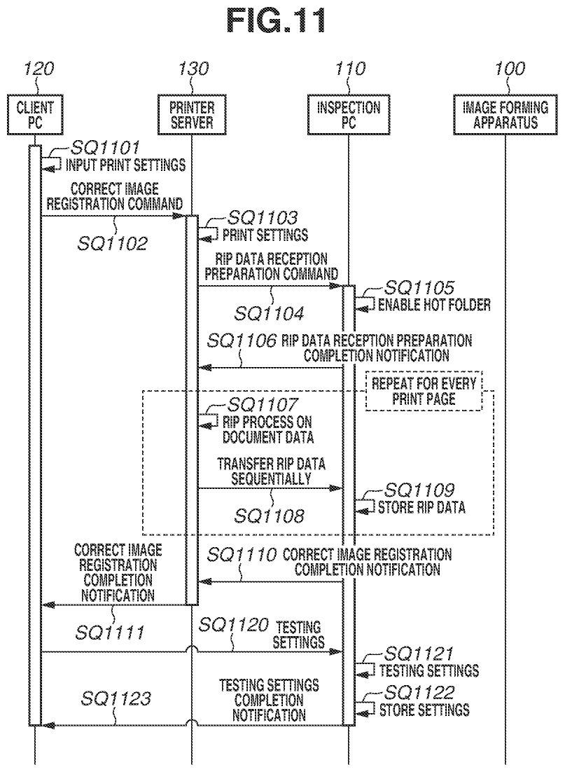

FIG. 11 is a diagram illustrating a process procedure for registering correct images and testing settings in an inspection system by the user before testing. In this procedure, the printer server 130 generates RIP images from document data and stores the generated RIP images as correct image data, and a setting to use the correct image data in testing is configured. By carrying out the procedure, the registration of correct images and testing settings prior to the printed product testing is completed.

For the processes in FIG. 11, the client PC 120, the printer server 130, the inspection PC 110, and the image forming apparatus 100 receive commands from a user 301 and perform processing described below. Further, the client PC 120 executes the process in response to receiving an instruction to start the correct image registration from the user.

At this time, the process of the inspection PC 110 is executed by program codes stored in the storage unit 116 being loaded into the RAM 113 and the apparatus control unit 111 being controlled by the CPU 112. Further, the process of the client PC 120 is executed by program codes stored in the storage unit 126 being loaded into the RAM 123 and the apparatus control unit 121 being controlled by the CPU 122. Further, the process of the printer server 130 is executed by program codes stored in the storage unit 136 being loaded into the RAM 133 and the apparatus control unit 131 being controlled by the CPU 132. Further, the process of the image forming apparatus 100 is executed by program codes stored in the storage unit 203 being loaded into the RAM 202 and the apparatus control unit 200 being controlled by the CPU 201.

According to the present exemplary embodiment, the printer server 130 and the inspection PC 110 communicate job information with each other. According to the present exemplary embodiment, the printer server 130 and the inspection PC 110 use a JavaScript Object Notation (JSON) format or an Extensible Markup Language (XML) format as a communication method.

First, in step SQ1101, the client PC 120 configures information related to the print settings for the document data to be tested based on instructions from the user.

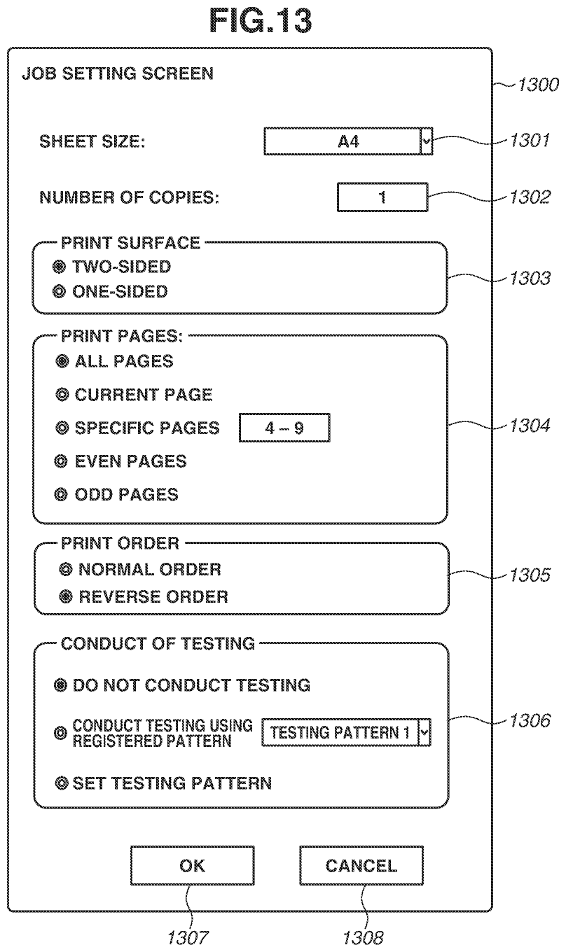

FIG. 13 is a diagram illustrating an example of UIs for configuring information related to the print settings.

A UI 1300 in FIG. 13 is a UI screen for inputting the print settings related to the inspection process and is displayed on the UI unit 128 of the client PC 120.

First, a list box 1301 is similar to the list box 601 according to the first exemplary embodiment, so that redundant descriptions thereof are omitted.

Next, a textbox 1302 is similar to the textbox 803 according to the first exemplary embodiment, so that redundant descriptions thereof are omitted.

Next, a radio button 1303 is similar to the radio button 602 according to the first exemplary embodiment, so that redundant descriptions thereof are omitted.

Next, a UI 1304 is similar to the UI 804 according to the first exemplary embodiment, so that redundant descriptions thereof are omitted.

Next, a radio button 1305 is similar to the radio button 805 according to the first exemplary embodiment, so that redundant descriptions thereof are omitted.

Next, a UI 1306 is a UI group for setting whether to conduct the testing selected by the user using a radio button method and a list box method. Patterns that can be selected using a radio button include “do not conduct testing”, “conduct testing using registered pattern”, and “set testing pattern”.

The radio button “do not conduct testing” is a radio button that is selected not to conduct testing. If the “do not conduct testing” is selected, the subsequent correct image registration process and the subsequent testing are not performed.

The radio button “conduct testing using registered pattern” is a radio button that is selected to conduct testing using a registered pattern with a set of the testing settings configured in FIG. 7. The registered patterns can be registered in the testing settings, and in a state where the UI 1306 is selectable, a list box of the registered patterns is displayed, and a registered pattern can be selected. If the radio button “conduct testing using registered pattern” is selected to conduct testing using the selected registered pattern, testing is performed without performing the subsequent correct image registration process.

The radio button “set testing pattern” is a radio button that is selected to perform correct image registration and configure the testing settings.

A button 1307 is a button that the user presses to store the setting values set by the user after all the print settings related to the inspection process are completed. A button 1308 is a button that the user presses to cancel the settings related to the inspection process. If the button 1308 is pressed by the user, information being configured is discarded, and the correct image registration procedure ends.

The UIs for configuring the print settings related to the inspection process according to the present exemplary embodiment have been described above.

Next, in step SQ1102, the client PC 120 transmits, to the printer server 130, a command to execute the correct image registration process. Specifically, a command to generate RIP data from document data and transfer the data to the inspection PC 110 is issued. According to the present exemplary embodiment, the document data to be source data for generating RIP data is transmitted at this time from the client PC 120 to the printer server 130.

Next, in step SQ1103, the printer server 130 stores the settings for performing the RIP process based on the print settings configured in step SQ1101.

Next, in step SQ1104, the printer server 130 transmits, to the inspection PC 110, a command to prepare for receiving RIP data transferred from the printer server 130.

Next, in step SQ1105, the inspection PC 110 enables a folder to which RIP data is to be transferred as a monitoring target hot folder. While a predefined folder is designated as a hot folder according to the present exemplary embodiment, the user can designate a folder. In this case, a transfer destination folder is also set on the printer server 130.

The inspection PC 110 checks whether an event of file transfer to the monitoring target hot folder has occurred, and once the RIP data transfer is completed, the subsequent correct image registration process is performed.

Next, in step SQ1106, the inspection PC 110 notifies the printer server 130 that the sequence of actions for receiving RIP data is complete.

Next, in step SQ1107, the printer server 130 performs the RIP process on each page individually and generates RIP data based on the document data received from the client PC 120 in step SQ1102 and the information related to the print settings configured in step SQ1103.

Next, in step SQ1108, each time one page of the RIP data is generated in step SQ1107, the printer server 130 sequentially transfers the generated RIP data to the monitoring target hot folder on the inspection PC 110.

Next, in step SQ1109, the inspection PC 110 sequentially stores the RIP data received in step SQ1108. Then, steps SQ1107 to SQ1109 are repeated for every print page of the document data.

Next, in step SQ1110, the inspection PC 110 stores the RIP data received in step SQ1109 as correct images and notifies the printer server 130 that the registration is complete.

Next, in step SQ1111, the printer server 130 having received the notification in step SQ1110 notifies the client PC 120 of the completion of the correct image generation and registration.

Next, steps SQ1120 to SQ1123 are similar to steps SQ340 to SQ343 according to the first exemplary embodiment, so that redundant descriptions thereof are omitted.

The process procedure for registering correct images and testing settings before testing according to the present exemplary embodiment has been described above.

### [Testing Execution Procedure of Inspection System]

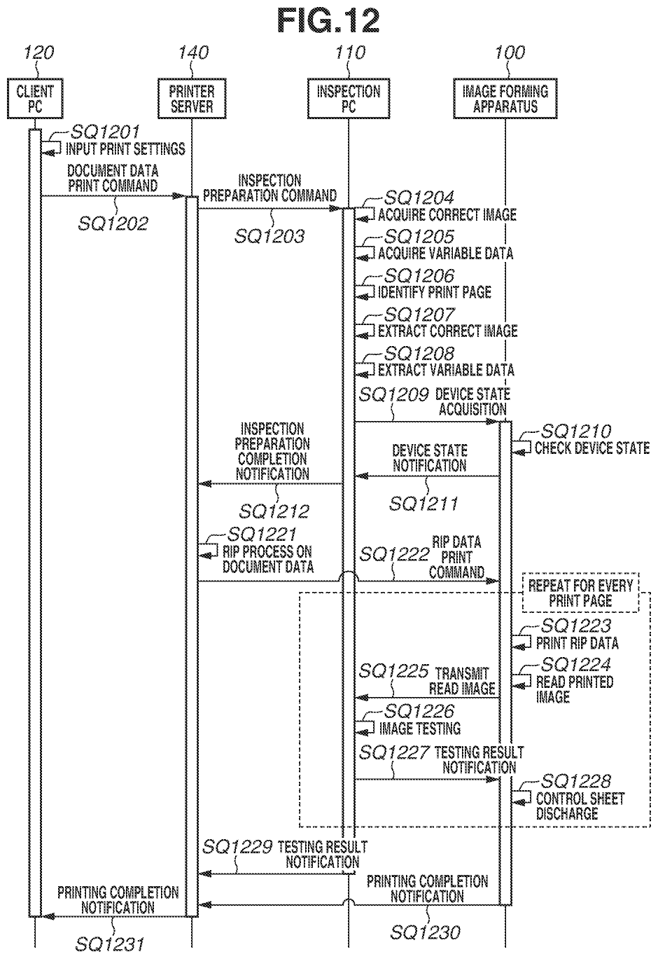

FIG. 12 is a diagram illustrating a process procedure in which the user performs printing using the image forming apparatus 100 via the printer server 130 and the inspection PC 110 performs testing to determine whether the printed product includes a defective image based on the testing settings configured in FIG. 3. A basic configuration of FIG. 12 is similar to that of FIG. 4 according to the first exemplary embodiment, so that redundant descriptions thereof are omitted.

First, in step SQ1201, the client PC 120 configures, based on a user instruction, the print settings that are to be commanded to the image forming apparatus 100 in performing printing and testing. In step SQ1201, the print settings to be referred to are configured in step SQ1101, so that redundant descriptions thereof are omitted. While the print settings to be referred to are configured in step SQ1101 according to the present exemplary embodiment, the print settings in testing in FIG. 8 can be displayed if printing of a job registered in advance or printing and testing of a job tested previously are to be performed again.

Next, in step SQ1202, the client PC 120 issues, to the printer server 130, a command to print using the document data and the print settings designated by the user.

Next, in step SQ1203, the printer server 130 issues an inspection preparation command to the inspection PC 110. The testing settings for use in inspection configured in step SQ1121 and the print settings configured in step SQ1201 are used.

Next, steps SQ1204 to SQ1211 are similar to steps SQ403 to SQ410 according to the first exemplary embodiment, so that redundant descriptions thereof are omitted.

Next, in step SQ1212, the inspection PC 110 notifies the printer server 130 that the preparation for executing the inspection is complete based on the printable and inspectable state notified in step SQ1210.

Next, steps SQ1221 to SQ1228 are similar to steps SQ421 to SQ428 according to the first exemplary embodiment, so that redundant descriptions thereof are omitted.

Next, in step SQ1229, the inspection PC 110 notifies the printer server 130 that the testing of the printing target pages is complete.

Next, in step SQ1230, the image forming apparatus 100 notifies the printer server 130 that the printing of the printing target pages is complete.

Next, in step SQ1231, the printer server 130 having received the testing completion notification in step SQ1229 or the printing completion notification in step SQ1230 notifies the client PC 120 that the printing is complete.

If the printer server 130 and the inspection PC 110 can communicate job information with each other as in the present exemplary embodiment, the settings related to printing in FIG. 13 can be configured only on the printer server 130. For example, communicating the print settings configured as job information in FIG. 13 from the printer server 130 to the inspection PC 110 makes it unnecessary for the user to configure the print settings for the inspection PC 110, making it possible to simplify the process related to the testing settings. Furthermore, collectively configuring the print settings including the testing in step SQ1101 makes it possible to skip the print settings before testing that are configured in step SQ1201. This makes it possible to perform the sequence of operations from the correct image registration to the printing and testing without instructions from the user.

With the foregoing configuration according to the present exemplary embodiment, the inspection PC 110 and the printer server 130 notify job setting information to each other and use RIP images as correct images, and printing target pages are identified based on the print page setting in testing. Printed image testing and data inspection can be performed in which correct images and correct character strings of reference data match.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-120518, filed Jul. 25, 2023, which is hereby incorporated by reference herein in its entirety.

What is claimed is:

1. A testing apparatus configured to connect to an image forming apparatus, the testing apparatus comprising:
a controller having one or more processors which executes instructions stored in one or more memories, the controller being configured to:
extract a character string from a designated area on a scanned image acquired by scanning a printed product with an image printed thereon based on a job;
acquire information regarding the job; and
perform testing on the printed product based on the acquired information about the job by comparing the character string extracted by an extraction unit with a correct value referred to from reference data.

2. The testing apparatus according to claim 1, wherein the controller generates second reference data by rearranging the correct value in first reference data stored in advance based on the acquired information about the job, and the controller performs the testing on the printed product using the second reference data.

3. The testing apparatus according to claim 1, further comprising a user interface (UI),
wherein the controller acquires the information about the job via a screen displayed on the UI.

4. The testing apparatus according to claim 1, wherein the controller acquires information about a page to be printed from information about a job for printing using the image forming apparatus.

5. The testing apparatus according to claim 4, wherein the information about the page to be printed is setting information about a range of pages to be printed.

6. The testing apparatus according to claim 4, wherein the information about the page to be printed is a print order setting.

7. The testing apparatus according to claim 1, wherein the correct value corresponding to a character string extracted from a scanned image of a first page is stored in a first row in the reference data, and the correct value corresponding to a character string extracted from a scanned image of a second page is stored in a row following the first row in the reference data.

8. The testing apparatus according to claim 7, wherein in a case where the acquired information about the job is information indicating that printing is to be performed from the first page, the controller performs the testing on the printed product by referring to the correct value corresponding to the first page and the correct value corresponding to a page following the first page in the reference data.

9. The testing apparatus according to claim 1, wherein the reference data is a comma-separated values (CSV) file.

10. The testing apparatus according to claim 1, wherein the controller extracts the character string from an image of the designated area based on a character string testing setting.

11. The testing apparatus according to claim 1, wherein the controller extracts the character string from a code image of the designated area based on a barcode testing setting.

12. The testing apparatus according to claim 1, wherein the designated area is a variable area where printing content changes for each page of the printed product.

13. The testing apparatus according to claim 1, wherein the reference data is variable data corresponding to the designated area.

14. The testing apparatus according to claim 1, wherein the controller rearranges the correct image based on the acquired information about the job and performs the testing on the printed product based on the rearranged correct image and the scanned image.

15. A testing system including a testing apparatus configured to connect to an image forming apparatus, the testing system comprising:
a controller having one or more processors which executes instructions stored in one or more memories, the controller being configured to:
extract a character string from a designated area on a scanned image acquired by scanning a printed product with an image printed thereon based on a job;
acquire information regarding the job; and
perform testing on the printed product based on the acquired information about the job by comparing the character string extracted by an extraction unit with a correct value referred to from reference data.
